(19) United States
(12) Patent Application Publication
(10) Pub. No.: US 2009/0267476 A1
(43) Pub. Date: Oct. 29, 2009

(54) LAMP WITH ONE FILAMENT FOR A VEHICLE HEADLAMP WITH A LOW BEAM, FOG LIGHT, TURNING LIGHT OR BENDING LIGHT FUNCTION

(75) Inventor: Lukas Kuepper, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,998

(22) PCT Filed: Apr. 10, 2006
(86) PCT No.: PCT/IB2006/051087

§ 371 Date: Oct. 9, 2007

(30) Foreign Application Priority Data
Apr. 12, 2005 (EP) 05102875.1

(51) Int. Cl. H01K 1/26

(52) U.S. Cl. 313/113; 313/117

(57) ABSTRACT

The invention relates to a lamp with one filament for a vehicle headlamp with a low beam, fog light, turning light or bending light function, which comprises at least an outer tube (3) and a light-emitting region (4) and which emits at least visible light from a number of regions of the outer tube (3), wherein at least one partial coating (2) is arranged on the outer tube (3) in such a way that, when the low beam, fog light, turning light or bending light function is implemented, the area of the traffic space which lies below the light/dark cut-off (F) can be illuminated in a first defined region with increased intensity and in a second defined region with reduced intensity and the partial coating (2) is an at least partially reflective coating.

The invention relates to a lamp with one filament for a vehicle headlamp with a low beam, fog light, turning light or bending light function, which comprises at least an outer tube and a light-emitting region and which emits at least visible light from a number of regions of the outer tube, wherein at least one partial coating is arranged on the outer tube in such a way that, when the low beam, fog light, turning light or bending light function is implemented, the area of the traffic space which lies below the light/dark cut-off (F) can be illuminated.

Within the context of the invention, the term “outer tube” refers to the outermost tube in the case of lamps with more than one tube and to the single tube in the case of lamps with just one tube.

Within the context of the invention, lamps are incandescent lamps, in particular halogen lamps, such as the H1, H7, H9 and H11 lamps from the company Philips for example.

The light-emitting region in the case of incandescent lamps is mainly the region of the incandescent filament.

Within the context of the invention, vehicle headlamps with a low beam function are all headlamps which produce a light/dark cut-off, such as, for example, pure low beam headlamps or combined full beam and low beam headlamps. Pure fog light headlamps, combined low beam and fog light headlamps and also bending light headlamps are also relevant in this respect.

Lamps which are used for this field of application are for example incandescent lamps, in particular halogen lamps, with one filament.

Such lamps which are to be used for vehicle headlamps are subject to international standards in terms of their most important parameters, such as for example the SAE and ECE standards, which relate specifically to the European or US market. By way of example, the light intensities which are to be observed in each case at defined locations are precisely defined. For example, according to regulation E112 which is applicable in Europe, the light intensities in the right-hand half of the traffic space must meet certain minimum values, and the light intensities in the left-hand half of the traffic space must not exceed defined maximum values.

A limited redistribution of the light intensities from the left-hand half into the right-hand half of the traffic space is therefore more desirable than a uniform intensity distribution as obtained with an uncoated light source from the prior art.

This is because headlamps with a low beam function are usually equipped with lamps which emit visible light with an almost uniform intensity in all spatial directions perpendicular to the axis of the filament, so that a homogeneously illuminated traffic space then usually results.

It is known that an increase in the light intensity improves the visibility of hazards in the traffic space, such as traffic signs for example, so that these can be perceived better and/or sooner by the driver of the vehicle, as a result of which road safety can usually be increased.

WO 2004/053924 A2 discloses a lamp for a vehicle headlamp with a low beam function, which comprises an outer tube and a light-emitting region and which emits at least visible light of different color from a number of regions of the outer tube, wherein at least one partial coating is arranged on the outer tube in such a way that, when the low beam function is implemented, at least the region of the traffic space which lies above the light/dark cut-off can be at least partially illuminated with visible colored light which is scattered at the partial coating. At the same time, using this lamp, it is possible for the region of the traffic space which lies below the light/dark cut-off to be illuminated in defined regions with visible light of different color. For this partial coating, absorption coatings are primarily described, since scattered light which is scattered through the partial coating is to pass into the traffic space above the light/dark cut-off. However, such scattered light is undesirable in certain applications.

Hazards or traffic signs which, in the case of traffic driving on the right, are located at the right-hand edge of the road in the direction of travel of the vehicle are difficult for the driver of the vehicle to see, particularly in wet weather.

There is a need for lamps, in particular halogen lamps, which, when implementing their primary lighting function, illuminate the traffic space below the light/dark cut-off in a defined manner, possibly in multiple colors. These lamps should not exhibit, above the light/dark cut-off, any scattered light caused by a partial coating, and, particularly in collaboration with a conventional reflector in a known manner, should illuminate the traffic space below the light/dark cut-off in different regions with different intensities. Here, the aim would be to achieve an increase in light intensity—in the case of traffic driving on the right—in the driver-side traffic space, particularly in the areas as far away as possible from the vehicle, wherein no increase in light intensity should be obtained in the region of the oncoming traffic. It should be possible for defined regions of the traffic space in front of the vehicle, namely the aforementioned regions, to be illuminated with higher and lower intensity.

It is an object of the invention to provide a lamp comprising such a coating and a lighting device comprising such a lamp, which can be efficiently manufactured in industrial mass production, exhibits a perceivable, differentiated light intensity in defined regions of the traffic space below the light/dark cut-off, and thus allows an increase in road safety when implementing its primary lighting function.

The object of the invention is achieved by the features of claim 1.

It is essential to the invention that at least one partial coating is arranged on the outer tube in such a way that, when the low beam, fog light, turning light or bending light function is implemented, the area of the traffic space which lies below the light/dark cut-off can be illuminated in a first defined region with increased intensity and in a second defined region with reduced intensity and the partial coating is an at least partially reflective coating.

This illumination takes place as a result of the functional collaboration of the lamp according to the invention, in the operating state thereof, with a conventional reflector in a known manner.

Within the context of the invention, conventional reflectors are in particular commercially available reflectors for incandescent lamps, which in particular have a rotation-symmetrical structure in reflection headlamps and are adapted to the primary function of the respective lamp in a known manner, for example in terms of shape, structure and choice of material.

The reflector may be either part of the lamp or part of the structural unit in which the lamp can be inserted for operation, without said lamp itself comprising a reflector.

The lamp can in principle be used both in projection headlamps and in reflection headlamps, wherein the partial coating must accordingly be arranged differently in relation to the installed position of the lamp, in a known manner.

By virtue of the solution according to the invention, the emitted quantity of light is distributed in such a way that—in the case of traffic driving on the right—an increase in light intensity is achieved in the region of the traffic space on the driver's side and a reduction in light intensity is achieved in the region of the oncoming traffic of the traffic space, compared to a lamp without such a partial coating.

When using the lamp for lighting purposes for vehicles in countries with traffic which drives on the left, the arrangement of the lamp in the reflector must be changed accordingly.

The choice of the at least partially reflective coating depends inter alia on the criterion as to whether this coating is or is not color-neutral with respect to the other lamp properties. A color-neutral coating is desired.

A partial coating which within the context of the invention does not cover the entire area of the surface of the lamp tube from which the emitted light exits from the outer tube when implementing the low beam function, may be homogeneous or inhomogeneous in particular with regard to layer structure, layer thickness and layer composition, depending on the desired function of the coating or of the parts of the coating.

Such a coating may also consist of a number of different partial regions which are arranged in a defined manner on the lamp tube, in particular the outer tube, depending on their respective function.

When implementing the low beam function, the traffic space below the light/dark cut-off can be illuminated in such a way that the light intensity is reduced in a first region and an increased light intensity is achieved in a second region on account of the partial coating.

It is preferred that the lamp with one filament is a halogen lamp, since the solution according to the invention can be transferred particularly effectively thereto within the context of mass production, particularly for the replacement parts market.

It is furthermore preferred that the at least partially reflective coating has a degree of reflection of more than 20% and less than or equal to 100%. With this degree of reflection, differences in terms of intensity can be perceived particularly well.

It is moreover preferred that the at least partially reflective coating is an interference coating.

Interference coatings usually do not cause any scattered light. Moreover, the absorption of visible light through interference coatings is negligible. It is preferred that the at least partially reflective coating is an interference coating which reflects in particular color-unfiltered light. In this way, this reflected, color-neutral light passes into the region toward the right-hand edge of the road—in the case of traffic driving on the right. This makes it possible for the light intensity in the region of the right-hand edge of the road approx. 50 to 100 meters in front of the vehicle to be increased compared to a lamp without such an interference coating.

With respect to the arrangement and form of the partial coating, it is preferred that the coating is formed in a strip-like manner, wherein the longest dimension thereof is arranged parallel to the longitudinal axis of the lamp. This form makes it possible in particular for this coating to be produced in a technologically simple manner.

In the case of traffic driving on the right, it is particularly preferred that the coating, on a cylindrical outer tube, with respect to the horizontal installed position of the lamp, covers a segment area having a width of 45°+/−45° and/or 315°+/−45°, particularly preferably 45°+/−25°, of its smaller dimension.

The coordinate system will be understood in such a way that the coordinates 0° and 180° lie on the imaginary horizontal axis of symmetry of the lamp, and the coordinates 90° and 270° lie on the imaginary vertical axis of symmetry of the lamp, wherein the 90° coordinate is located above the 270° coordinate in the coordinate system.

A defined dimensioning and position of the partial coating increases the fundamental effects of the invention. It has been found that a partial coating running along the tube axis at a random position on a lamp, in particular on a halogen lamp, generally does not give rise to a visible increase in light intensity in the traffic space.

The object of the invention is also achieved by a lighting unit which comprises at least one lamp as claimed in claims 1 to 9.

The lighting unit may comprise either a reflection headlamp or a projection headlamp.

The invention will be further described with reference to examples of embodiments shown in the drawings to which, however, the invention is not restricted.

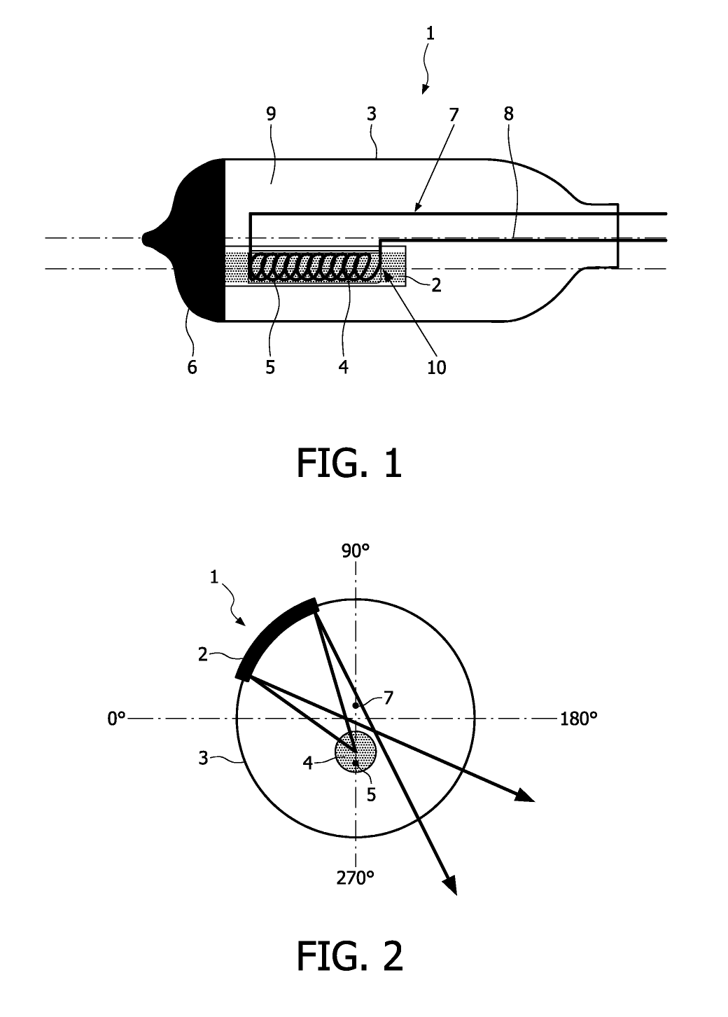

FIG. 1 shows a schematic side view of a halogen lamp for a reflection headlamp.

FIG. 2 shows a schematic sectional view through the cylindrical part of the lamp 1.

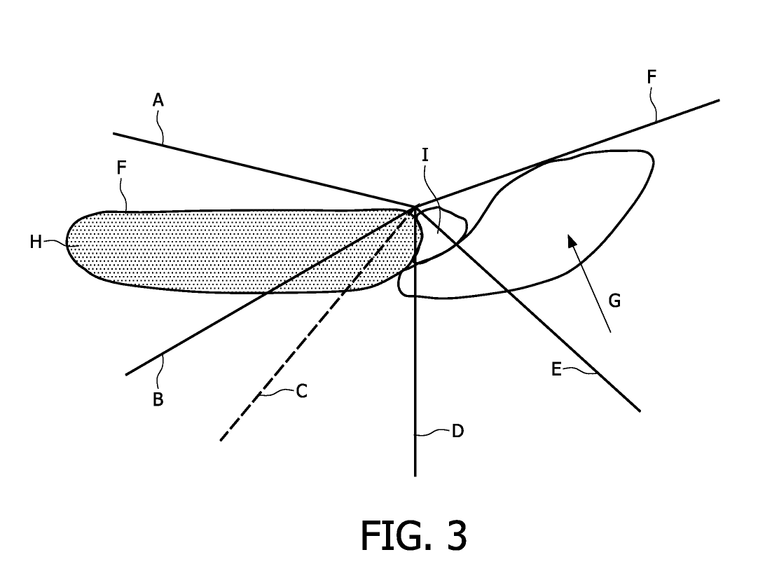

FIG. 3 shows a schematic diagram of the light distribution in the traffic space of a lamp as shown in FIG. 1.

FIG. 1 shows, in a schematic side view, one embodiment of a lamp 1 according to the invention, namely a halogen lamp, for a reflection headlamp prior to installation of the lamp 1 in a reflector. As the light source of the lamp 1, a filament 5 is arranged within the lamp tube, which lamp tube in this case is also the outer tube 3 of the lamp 1. The filament 5, which is approximately 5 mm long and 1 mm wide, is connected to a return pole 7 and to a power supply 8 in a conventional manner.

In respect of its outer contour, the light-emitting region 4 is delimited mainly by the area of the filament 5, in particular the outer regions thereof. The light-emitting region 4 can be described as approximately cylindrical, wherein its longitudinal axis runs parallel to the longitudinal axis 10 of the filament 5 and of the partial coating 2. The approximately cylindrical light-emitting region 4 has a diameter of approx. 1.2 mm and is approximately 5.2 mm long.

The outer tube 3 is joined to a cap (not shown in FIG. 1) in a gas-tight manner. A protective screen 6 in the form of a partial, light-impermeable coating is applied to the outer surface of the outer tube 3, at the end which points in the direction of the traffic space in the illustrated installed position.

The partial coating 2 is overall arranged only on part of the outer surface of the outer tube 3.

The outer tube 3 moreover has a region 9 which does not bear any coating, so that primarily unfiltered light exits from this region 9.

The partial coating 2 is an interference coating which comprises a number of layers.

The requirements regarding the temperature-stability of the partial coating 2 are determined in particular by the temperatures of 600 to 800° C. which regularly occur on the outer tube 3 of the lamp 1.

The partial coating 2, which is a dielectric coating, consists of at least two and at most five layers and is applied by a sputtering process in a known manner, wherein the coated region is masked with a mechanical mask. In this process, silicone dioxide is used as a material with a low refractive index and titanium dioxide is used as a material with a high refractive index. Alternatively, use may be made of zirconium dioxide or tantalum pentoxide as materials with a higher refractive index. The individual layers may in each case have a thickness of 20 to 120 nm, wherein the overall coating has a thickness of at least 50 nm and at most 1500 nm. Further details or indications regarding the detailed description of the partial coating can be found in US 20050024880.

The width of this strip-like interference filter 2 is approx. 4 mm and its longitudinal dimension is approx. 8 mm. This strip-like interference filter, which has at least the width of the light-emitting region 4, is applied to the surface of the outer tube 3.

FIG. 2 shows a schematic sectional view through the cylindrical part of the lamp 1. The light-emitting region 4 and the filament 5 are arranged below the point of intersection of the horizontal and vertical axes of symmetry of the outer tube 3, said axes of symmetry being shown as dash-dotted lines in FIG. 1. The at least partially reflective coating 2 is arranged on part of the outer surface of the lamp tube 3. On the cylindrical outer tube 3, the coating 2 covers a segment area having a width of 45°+/−25° of its smaller dimension. Here, the first coordinate, namely 45°, describes the position of the imaginary center point of the coating 2 on the surface of the outer tube 3 of the lamp 1 in a sectional view analogous to FIG. 2. The second coordinate, namely +/−25°, describes the smaller dimension of the strip-like coating 2 arranged in segment form.

FIG. 2 shows one example of a reflection headlamp for traffic driving on the right, wherein, in the installed position, the person looking at FIG. 2 is looking from the traffic space toward the reflection headlamp. (If, on the other hand, FIG. 2 showed an example of a projection headlamp for traffic driving on the right, the person looking at FIG. 2—in the installed position—would be looking from the projection headlamp toward the traffic space.)

In FIG. 2, the lamp 1 is shown in a manner analogous to the installed position in a conventional reflector (not shown), which ensures the effect according to the invention. This horizontal installed position of the lamp 1 in the reflector, that is to say with the filament and the return pole 7 arranged more or less on the vertical (imaginary) axis of symmetry, wherein the filament 5 is positioned below the return pole 7, relates to a use of a headlamp for traffic driving on the right.

FIG. 3 shows a schematic diagram of the light distribution in the traffic space of a lamp according to the invention as shown in FIG. 1 on a vertically arranged screen, e.g. m in front of the vehicle when implementing the low beam function.

FIG. 3 contains the line A as the line on which the eyes of the driver of an oncoming vehicle move; B is the line of the left-hand edge of the road; C is the line of the center of the road; D is the line of the center of the right-hand lane; E is the line of the right-hand edge of the road; and F is the line of the light/dark cut-off; H is the region of reduced light intensity, and G and I are the regions of increased light intensity which are delimited toward the top by the line F of the light/dark cut-off.

Light which passes through the partial coating 2 is projected into the traffic space in the vicinity of the light/dark cut-off F. Light which is reflected through the partial coating 2 appears in the traffic space in the regions G and I. The light/dark cut-off F is the region in the traffic space which separates the traffic space which is illuminated by the headlamp from the traffic space which is not illuminated by it.

1. A lamp with one filament for a vehicle headlamp with a low beam, fog light, turning light or bending light function, which comprises at least an outer tube (3) and a light-emitting region (4) and which emits at least visible light from a number of regions of the outer tube (3), wherein at least one partial coating (2) is arranged on the outer tube (3) in such a way that, when the low beam, fog light, turning light or bending light function is implemented, the area of the traffic space which lies below the light/dark cut-off (F) can be illuminated in a first defined region with increased intensity and in a second defined region with reduced intensity and the partial coating (2) is an at least partially reflective coating.

2. A lamp as claimed in claim 1, characterized in that the lamp (1) is a halogen lamp.

3. A lamp as claimed in claim 1, characterized in that the at least partially reflective coating has a degree of reflection of more than 20% and less than or equal to 100%.

4. A lamp as claimed in claim 1, characterized in that the at least partially reflective coating is an interference coating.

5. A lamp as claimed in claim 1, characterized in that the at least partially reflective coating is an interference coating which reflects in particular color-unfiltered light.

6. A lamp as claimed in claim 1, characterized in that the coating (2) is formed in a strip-like manner, wherein the longest dimension thereof is arranged parallel to the longitudinal axis of the lamp.

7. A lamp as claimed in claim 6, characterized in that the coating (2) covers on a cylindrical outer tube (3) in its smaller dimension a segment area having a width of 45°+/−45° and/or 315°+/−45°, particularly preferably 45°+/−25° and/or 315°+/−25°.

8. A lamp as claimed in claim 1, characterized in that, when the respective function of the lamp is implemented, the traffic space below the light/dark cut-off (F) can be illuminated in such a way that yellow light dominates in a first region (H), blue light dominates in a second region (G) and light which is not substantially affected by the coating (2) dominates in a third region (I).

9. A lamp as claimed in claim 1, characterized in that the coating (2) is homogeneous or inhomogeneous in terms of the degree of reflection.

10. A lighting device, at least comprising a lamp (1) as claimed in claim 1.
